(19) United States
(12) Patent Application Publication
(10) Pub. No.: US 2005/0129608 A1
(43) Pub. Date: Jun. 16, 2005

(54) Method for producing fullerenes

(76) Inventors: Hiroaki Takehara, Kitakyushu-shi (JP); Tsuyoshi Takakura, Kitakyushu-shi (JP); Mineyuki Arikawa, Kitakyushu-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/735,844

(22) Filed: Dec. 16, 2003

(51) Int. Cl. C01B 31/00

(52) U.S. Cl. 423/445 B

(57) ABSTRACT

A hydrocarbon fuel is either imperfectly combusted or thermally decomposed in a reactor 11, thereby producing a high-temperature gas flow containing fullerenes and soot. A mixture of the fullerenes and soot is collected from the gas flow using a filtering unit 12 which includes a heat-resistant filtering member made of either a porous ceramic material or a porous metal material. The fullerenes are collected from the mixture by usual means. These processes according to the method of the present invention make it possible to produce a large amount of fullerenes.

### BACKGROUND OF THE INVENTION

The present invention relates to a method for producing fullerenes (new carbon materials) based on the either imperfect combustion or thermal decomposition of a hydrocarbon fuel. The fullerenes are closed cage carbon molecules such as, e.g., C60, C70, C76, C78, C82, C84, C86, C88, C90, C92, C94, and C96. The fullerenes also include higher-order fullerenes that are insoluble in a usual solvent such as toluene or xylene.

Closed cage carbon molecules, fullerenes, as discussed above have recently been discovered. The fullerenes exhibit unique solid-state properties from their unusual molecular structures. Earnest studies have been made to determine the properties of the fullerenes, and to develop the use of the fullerenes. The fullerenes are expected to be applicable in the fields of, e.g., diamond coating, battery materials, painting, thermal insulating materials, lubricants, pharmaceuticals, and cosmetics. Methods such as arc discharging, resistance heating, laser evaporation, and combustion are known as methods for producing the fullerenes. For example, a combustion method for imperfectly combusting cyclic aromatic hydrocarbons such as benzene and toluene is expected as a way of producing a large amount of the fullerenes at low costs.

Methods for producing the fullerenes in accordance with the combustion method are disclosed in, e.g., published U.S. Pat. No. 5,273,729 and U.S. patent application Publication No. US2003/0041732. According to the disclosed methods, a hydrocarbon fuel in a reactor under reduced pressure is incompletely combusted to yield the fullerenes; a filter collects a mixture containing the fullerenes and soot (hereinafter sometimes simply called “fullerene-containing soot”) that is contained in an exhaust gas from the reactor; and a solvent separates the fullerenes from the collected mixture. Since the reactor produces the exhaust gas having highly elevated temperatures as high as 1500 to 2000° C., a cooling unit at first cools down the exhaust gas to temperatures of at most 300° C. before the exhaust gas is allowed to flow through the abovementioned filter.

However, the mass production of the fullerenes according to the above methods must cool down a large quantity of the exhaust gas in a short time. This requirement must be met by the supply of both a large-scaled cooling unit and a large amount of cooling water. In order to provide a more efficiently operating cooling unit, a contact between the exhaust gas and a refrigerating portion of the cooling unit may be increased in area. However, such a countermeasure brings about a problem in which smoke dust and solidified fullerenes builds up on the increased contact portion, with the result that the cooling unit is likely to be clogged up therewith.

Another problem is that the exhaust gas from the reactor contains aromatic compounds such as polycyclic aromatic compounds (PAH), although situations are varied in dependence upon types of the hydrocarbon fuel. The aromatic compounds are usually vaporized at temperatures of 300° C. or less. When the exhaust gas from the reactor is cooled down to the temperatures of 300° C. or less, the fullerene-containing soot collected from the cooled exhaust gas using the filter is objectionably mixed with fluidized or solidified aromatic compounds. In general, the aromatic compounds are more soluble in the solvent than the fullerenes are. This means that, when the fullerene-containing soot is extracted into the solvent, it is difficult to selectively extract only the fullerenes from the soot because almost all of the aromatic compounds in the soot are extracted into the extract fluid at one time. In order to obtain the fullerenes, as solids, from the extract fluid, the extract fluid may be, e.g., evaporated and dried to provide fullerene-based solids. Alternatively, the extract fluid may be evaporated to precipitate solids; the precipitated solids may be filtered and then dried, thereby providing the fullerene-based solids. In both cases, however, the fullerene-based solids contain polycyclic aromatic compounds of typically some 0.01 to 10%. Some ofthe polycyclic aromatic compounds may be physically detrimental.

### SUMMARY OF THE INVENTION

In view of the above, a first object of the present invention is to provide a method for producing fullerenes, operable to cool down an exhaust gas, i.e., a gas flow containing fullerenes and soot from a reactor using a cooling unit that has a small cooling capability.

A second object of the present invention is to provide a method for producing fullerenes, operable to readily remove polycyclic aromatic compounds from the exhaust gas when the exhaust gas contains those compounds.

To achieve the objects, a first aspect of the present invention provides a method for producing fullerenes, comprising: a first process of either imperfectly combusting or thermally decomposing a hydrocarbon fuel in a reactor, thereby producing a high-temperature gas flow containing the fullerenes and soot (an exhaust gas); a second process of collecting a mixture of the fullerenes and soot from the gas flow containing the fullerenes and soot using a filtering unit, the filtering unit including a heat-resistant filtering member made of either a porous ceramic material or a porous metal material as a raw material; and a third process of collecting the fullerenes from the mixture.

This system allows relatively high-temperature gas flow to be blown into the filtering unit, and the gas flow containing the fullerenes and soot from the reactor into the filtering unit can be maintained at high temperatures.

The high-temperature gas flow generated by the first process is desirably regulated in temperature by a temperature-regulating unit to the range of more than 300 to 600° C. (more preferably 350 to 500° C.). The regulated temperatures permit polycyclic aromatic compounds to remain vaporized. As a result, the polycyclic aromatic compounds are streamed in a gaseous state through the heat-resistant filtering members without being mingled with the mixture of the fullerenes and soot. As represented by benzopyrene, hydrogen atoms in each of the polycyclic aromatic compounds account for a smaller percentage of the composition than those in other aromatic compounds, and the polycyclic aromatic compounds are similar in composition to the fullerenes. As a result, when the polycyclic aromatic compounds are mixed with the fullerenes, such a mixture is likely to inhibit the reaction of the fullerenes, or to adversely affect the inherent properties of the fullerenes. In addition, some of the polycyclic aromatic compounds may be physically detrimental, and those polycyclic aromatic compounds are preferably present in as small amount as possible in view of safety. The gas flow having temperatures of more than 600° C. is objectionable because the fullerenes are partially or wholly vaporized at temperatures over 600° C.

A second aspect of the present invention provides a method for producing fullerenes as defined in the first aspect of the present invention, in which the step of collecting the fullerenes from the mixture according to the third process comprises methods “A” and “B”. The method “A” is operable to dissolve the mixture in a solvent (a solvent medium) to collect and separate the fullerenes from the mixture. The method “B” is operable to heat the mixture at high temperatures in the absence of oxygen to vaporize the fullerenes, thereby separating the fullerenes from the soot. Alternatively, a combination of the methods “A” and “B” makes it possible to separate the fullerenes from the mixture as well. In the alternative, the fullerenes insoluble in the solvent are collectable according to the method “B”.

For example, toluene or xylene operable to dissolve the fullerenes, not the soot is used as the solvent.

In the method for producing fullerenes according to the present invention, the heat-resistant filtering member is made of either porous ceramics or porous metal as a raw material, and is possible to fully withstand the high-temperature gas flow that is sufficient to retain the fullerenes in a solidified state, or rather in the form of fine powder. The soot predominantly includes amorphous carbon. Smaller-sized amorphous carbon is nearly 3 to 5 μm. The heat-resistant filtering member is formed with pores, each of which is sized to block the smaller-sized amorphous carbon from permeating the heat-resistant filtering member. A satisfactorily small-sized pore (e.g., 0.1 to 3 μm) is preferably reduced in thickness (e.g., some 0.5 to 5 mm) because a pressure loss decreases with a reduction in thickness. A ceramic heat-resistant filtering member is made of a ceramic material such as, e.g., alumina, silica, silicon carbide, cordierite (2MgO.2Al₂O₃.5SiO₂), zirconia, or a composite material selected therefrom. In addition, the ceramic heat-resistant filtering member is fabricated of any ceramic material that exhibits sufficient mechanical properties, even at high temperatures.

However, the ceramic heat-resistant filtering member decreases in strength with a reduction in thickness, and is likely to crack. Therefore, the heat-resistant filtering member is advisably made of porous metal. In this instance, the heat-resistant filtering member may be formed using either a plate member formed with many apertures or a metal mesh having very small openings, but a heat-resistant filtering member made of sintered metal is more advisable because the sintered metal itself includes many pores. The use of the sintered metal eliminates complicated working, and produces a low cost heat-resistant filtering member. The sintered metal can be, e.g., austenite-series stainless steel and other stainless steel. In some cases, the sintered metal can be either powder-like or fiber-like metal selected from one or two or more elements of usual iron, copper, brass, bronze, nickel, chrome, molybdenum, and tungsten, or alternatively may be formed by mixing the powder- or fiber-like metal with a small amount of ceramic fine powder. The heat-resistant filtering member fabricated of metal can be as very thin as some 0.2 to 3 mm, with a consequential reduction in pressure loss.

The heat-resistant filtering member has a filtration flow capability to filter the gas flow that streams through the heat-resistant filtering member. The filtration flow capability desirably ranges from, e.g., 0.2 to 10 m³/m²/minute (more preferably 1 to 5 m³/m²/minute) because the fullerenes and soot are collectable with high efficiency, and because the fullerenes and soot are easily removable from the heat-resistant filtering members when the heat-resistant filtering members are reversely cleaned. Although the pressures (static pressures) of the gas flow flowing through heat-resistant filtering members are unrelated to the filtration flow capability of each of the heat-resistant filtering members, the gas flow pressures (static pressures) range from, e.g., nearly 20 to 200 Torr in accordance with the present invention. The filtration flow capability of less than 0.2 m³/m²/minute requires the use of a heat-resistant filtering member that is large in area. The filtration flow capability of more than 10 m³/m²/minute objectionably feeds the soot in the form of fine powder into the heat-resistant filtering members. As a result, excessive pressures are applied to the heat-resistant filtering members when the heat-resistant filtering members are reversely cleaned. Furthermore, the fine power-like soot is prone to clogging up the heat-resistant filtering members, with a consequential reduction in lifetime of each of the heat-resistant filtering members.

In the method for producing fullerenes according to the present invention, any one of reactors of four types as discusses below may be employed, all of which are operable to produce the high-temperature gas flow containing the fullerenes and soot. The reactors include (1) an upright reactor, (2) an inverted reactor, (3) a horizontal reactor, and (4) a slanted reactor. The upright reactor as designated by the above (1) has a burner and an exhaust port disposed at lower and upper portions of the reactor, respectively. The burner is operable to either imperfectly combust or thermally decompose the hydrocarbon fuel. The exhaust port is operable to discharge the high-temperature gas flow containing the fullerenes and soot out of the reactor. The inverted reactor as designated by the above (2) has the burner and the exhaust port provided at the upper and lower portion of the reactor, respectively. The horizontal reactor as designated by the above (3) has the burner and the exhaust port positioned on one side of the reactor and the other, respectively. The slanted reactor as designated by the above (4) has the burner and the exhaust port positioned on one side of the reactor and the other, respectively. In particular, the use of the inverted reactor ensures that the soot is smoothly blown out of the reactor because the upwardly located burner remains opened without being plugged up with the soot that results from reaction.

In either case, the reactor desirably ranges in internal temperature from 1500 to 2500° C., and preferably ranges in pressure from some 20 to 200 Torr (more preferably from 30 to 80 Torr).

In the method for producing the fullerenes according to the present invention, the filtering unit includes a large number of cylindrical-shaped unit filter elements, each of which is made of the heat-resistant filtering member, and each of which has a bottom. The unit filter elements are divided into several gangs. The gas flow is preferably fed through each of the unit filter elements from the outside thereof to the inside thereof As discussed above, each of the unit filter elements is made of either the porous ceramics or the porous metal. Consequently, the unit filter elements can reversely be cleaned for each of the gangs, and the mixture attached to the unit filter elements is removable therefrom. As a result, the fullerenes and soot adhering to the unit filter elements can be collected therefrom without the filtering unit in operation being stopped.

The unit filter elements are cleaned by blowing an inert gas (e.g., nitrogen gas) into each of the unit filter elements from the inside to the outside thereof As a result, the fullerenes and soot sticking to each of the unit filter elements on the outer surface thereof are dropped and removed therefrom, and are ultimately collectable.

### BRIEF DESCRIPTION OF THE DRAWINGS

FIG. 1 is a descriptive illustration showing how fullerenes are produced in accordance with an embodiment of the present invention;

FIG. 2 is a graph illustrating how fullerene-containing soot is reduced in weight when the fullerene-containing soot is heated;

FIG. 3 is a graph illustrating results from the qualitative analysis of gases generated by heating the fullerene-containing soot; and

FIG. 4 is a graph illustrating a pressure loss of a unit filter element with reference to a gas flow rate. The unit filter element is made of sintered metal, and is an example of heat-resistant filtering members used in the method for producing the fullerenes according to the embodiment.

### DETAILED DESCRIPTION OF THE INVENTION

For a more complete understanding of the present invention, an embodiment incorporating the present invention is now described with reference to the accompanying drawings.

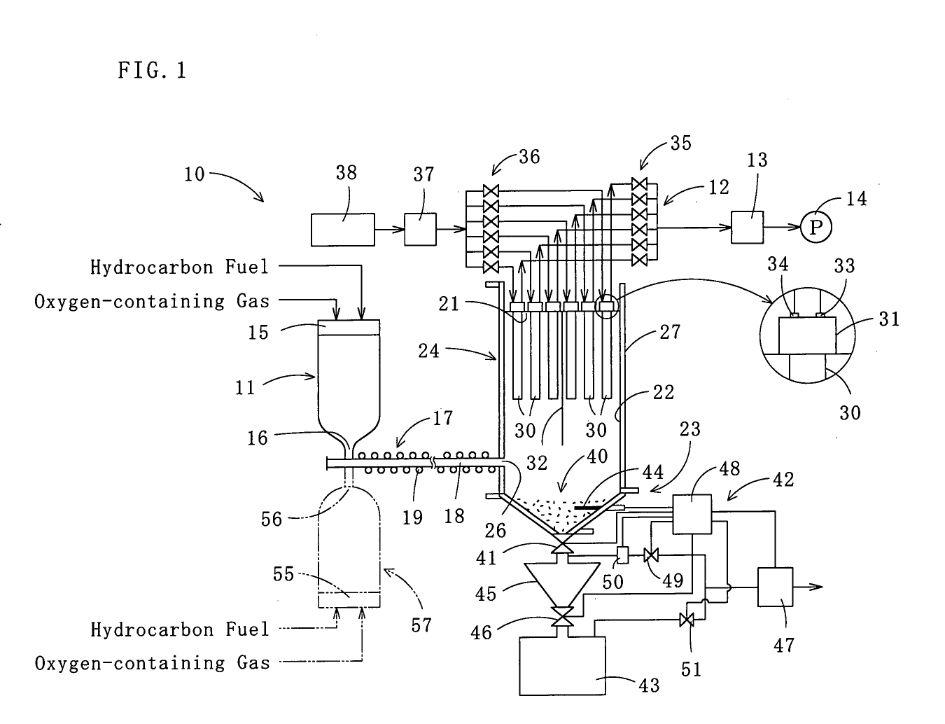

FIG. 1 illustrates fullerene-manufacturing equipment 10 suited for a method for producing fullerenes according to one embodiment of the present invention. As illustrated in FIG. 1, the fullerene-manufacturing equipment 10 includes a reactor 11, a filtering unit 12, a gas-cooling unit 13, and a vacuum pump 14. The reactor 11 is operable to imperfectly combust a hydrocarbon fuel to produce the fullerenes. The filtering unit 12 is operable to separate the fullerenes and soot from a gas flow containing the fullerenes and soot blown from the reactor 11. The gas-cooling unit 13 is operable to cool down the gas flow discharged from the filtering unit 12. The vacuum pump 14 is operable to discharge the gas flow out of the reactor 11, together with the fullerenes and the soot, while retaining the interior of the reactor 11 under reduced pressures. The following discusses details of each of the above components.

Pursuant to the present embodiment, the fullerenes are produced in accordance with a combustion method. Accordingly, the reactor 11 has internal pressure smaller than atmospheric pressure, and is preferably in a nearly vacuum state (e.g., at least 20 Torr and at most 200 Torr). The reactor 11 has a burner 15 and an exhaust port 16 disposed at upper and lower portions of the reactor 11, respectively. The burner 15 is operable to either incompletely burn or thermally decompose the hydrocarbon fuel. The exhaust port 16 is operable to discharge the high-temperature gas flow containing the fullerenes and soot (hereinafter called “exhaust gas”) out of the reactor 11. This reactor construction is advantageous in that an ejection port of the burner 15 is resistant to being clogged up with the soot formed within the reactor 11. The lower portion of the reactor 11 is gradually reduced in diameter toward the exhaust port 16, thereby smoothly blowing the fullerene-containing soot out of the reactor 11 through the exhaust port 16.

The interior of the reactor 11 is lined with refractories because the internal temperature of the reactor 11 is elevated to 1,500 to 2,000° C. The exterior of the reactor 11 is made of water-cooled, heat-resistant steel or stainless steel.

The burner 15 is supplied with a fuel gas that is a mixture of an oxygen-containing gas and a gaseous aromatic hydrocarbon fuel such as toluene or benzene (examples of the hydrocarbon fuels). In certain cases, an inert gas such as an argon gas may be added to the fuel gas. In this instance, those constituents are preferably mixed together in such a manner that a molar ratio of carbon to oxygen lies within the range of 0.97 to 1.36.

Aromatic hydrocarbons having the number of carbons falling in the range of six to twenty, e.g., benzene, toluene, xylene, naphthalene, methylnaphthalene, anthracene, and phenanthrene, are desirably employed as the above-described hydrocarbon fuel. In conjunction with those aromatic hydrocarbons, aliphatic hydrocarbons such as hexane, heptane, and octane may be used. As a further alternative, a hydrocarbon fuel having two or more five-membered rings, two or more six-membered rings or a mixture of one or more five-membered rings and one or more six-membered rings may be employed.

A temperature-regulating unit 17 is disposed between the reactor 11 and the filtering unit 12. The temperature-regulating unit 17 includes a piping passage 18 and a water-cooling pipe 19 that extends around the exterior of the piping passage 18. The piping passage 18 is made of a heat-resistant metallic material (e.g., stainless steel or heat-resistant steel). The exhaust gas containing the fullerenes and soot enters the piping passage 18 from the reactor 11 through the exhaust port 16 in a direction tangential to the piping passage 18. In the piping passage 18, the exhaust gas containing the fullerenes and soot flows in a swirl in efficient contact with a pipe wall of the piping passage 18, thereby cooling down the exhaust gas containing the fullerenes and soot to temperatures of, e.g., 300 to 600° C. (more preferably 350 to 500° C.). The exhaust port 16 in perpendicular contact with the piping passage 18 may alternatively be slanted at angles of, e.g., nearly 5 to 30 degrees in a direction oblique to the piping passage 18 in order to feed the exhaust gas in a direction consistent with a direction in which the piping passage 18 extends. The temperatures can be regulated in accordance with a change in length of the piping passage 18 and a change in either amount or temperature of supplied cooling water. The flow of the exhaust gas in a swirl inside the piping passage 18 as just discussed above is advantageously resistant to clogging up the piping passage 18 with the soot contained in the exhaust gas.

Pursuant to the present embodiment, the water-cooling pipe 19 spirally extends around the exterior of the piping passage 18, thereby forming the temperature-regulating unit 17. Alternatively, the exterior of the piping passage 18 may be jacketed. The soot-containing gases may be streamed turbulently through the piping passage 18, with the result that the soot-containing gases can positively be reduced in temperature. In this instance, however, the piping passage 18 is likely to be clogged up with the soot therein. Therefore, the soot-containing gases are desirably fed through the piping passage 18 as fast as possible.

The exhaust gas containing the fullerenes and soot controlled at the predetermined temperatures by the temperature-regulating unit 17 is supplied to the filtering unit 12. The filtering unit 12 has a casing 24 formed by a ceiling portion 21, a cylindrical body 22, and a conical portion 23. The conical portion 23 is integrally connected to the cylindrical body 22 at the bottom thereof The cylindrical body 22 has a connecting port 26 positioned at a lower portion thereof, through which the piping passage 18 is connected to the cylindrical body 22. The cylindrical body 22 and the conical portion 23 include a temperature-regulating jacket 27. The temperature-regulating jacket 27 is operable to adjust the inner surface temperature of the casing 24 by feeding a heat medium into the temperature-regulating jacket 27 through an incoming port of the temperature-regulating jacket 27 and subsequently by discharging the heat medium out of the temperature-regulating jacket 27 through an outgoing port thereof The inner surface temperature of the casing 24 can be regulated to, e.g., 300° C. in accordance with an appropriate adjustment in type, temperature, and flow rate of the heat medium that is circulated through the temperature-regulating jacket 27.

A large number of unit filter elements 30 are positioned within the filtering unit 12 at an upper portion of the filtering unit 12. Each of the unit filter elements 30 is formed by a heat-resistant filtering member. An opening 31 is formed on each of the unit filter elements 30 at the top end thereof The opening 31 extends upward from the ceiling portion 21. The unit filter elements 30 are partitioned by partition plates 32 into several filter element gangs. Each of the partition plates 32 is open at the bottom thereof The unit filter elements 30 are mounted to permit the main portions of the unit filter elements 30 to be located within the casing 24. Each of the unit filter elements 30 has a cylindrical shape with the bottom thereon. The openings 31 are designed to serve as exhaust ports, through which the filtered exhaust gas leaves the unit filter elements 30. The partition plates 32 can be made of, e.g., stainless steel or other heat-resistant steel. A cooling unit such as a water-cooled jacket may be disposed on each of the partition plates 32.

Each of the openings 31 includes an exhaust port 33 and an air-feeding port 34. The exhaust gas admitted into the unit filter elements 30 from the outer surfaces thereof toward the inner surfaces thereof leaves the unit filter elements 30 through the exhaust ports 33. For example, a nitrogen gas (an example of non-oxidized gases) enter the unit filter elements 30 through the air-feeding ports 34 to penetrate the unit filter elements 30 from the inner surfaces to the outer surfaces thereof. The unit filter element 30 is formed by a sintered metallic, heat-resistant filtering member that is made of high-temperature heat-resistant metal such as, e.g., stainless steel, Inconel, and Hastelloy. The sintered metal is an example of porous metal materials. The opening porosity, opening pore diameter, and opening pore-communicated state of the heat-resistant filtering member are controlled to provide a filtration flow capability of at least 0.2 m³/m²/minute. A preferred upper limit to the filtration flow capability is 10 m³/m²/minute. A still further preferred filtration flow capability ranges from at least 0.2 to at most 6 m³/m²/minute. In view of actual operations, the filtration flow capability may range from 1 to 5 m³/m²/minute.

Pursuant to the present embodiment, the unit filter element 30 is illustrated as a hollow body (a cylindrical object) having one end closed. Alternatively, another unit filter element in the form of a cylindrical body having both ends opened may be employed. In the alternative, the cylindrical body including upper and lower connection ports may be vertically positioned to expel the exhaust gas out of the cylindrical body through the upper connection port, but to feed reverse-cleaning gas into the cylindrical body through the lower connection port when necessary.

To fabricate the unit filter element 30 using a heat-resistant metal filtering member, metal as thin as, e.g., some 0.2 mm to 3 mm may be used.

Pursuant to the present embodiment, the unit filter elements are vertically positioned. Alternatively, they may be disposed horizontally. In the alternative, the cylindrical body having both ends opened may be used as the unit filter element to admit the exhaust gas into the cylindrical body through the opposite ends thereof, thereby filtering the fullerene-containing soot.

Pursuant to the present embodiment, the exhaust gas is introduced into the cylindrical unit filter elements from the outer surfaces to the inner surfaces thereof Alternatively, the exhaust gas may be admitted into the cylindrical unit filter elements in the opposite direction. In the alternative, each of the cylindrical unit filter elements desirably has the bottom end opened to permit the fullerene-containing soot to fall by gravity out of the cylindrical unit filter element when the cylindrical unit filter element is reversely cleaned.

Each of the exhaust ports 33 at the openings 31 is connected to the gas-cooling unit 13 through a corresponding opening and closing valve 35. The exhaust gas having flown though the filtering unit 12 is cooled down by the gas-cooling unit 13 to temperatures in the range of 100° C. to nearly an ordinary temperature before being conveyed to the vacuum pump 14. As a result, the fullerenes and soot in the exhaust gas adhere to the unit filter elements 30 at the outer circumferences thereof, but the attached fullerenes and soot are ultimately collected therefrom. The gas-cooling unit 13 is formed by a heat exchanger designed to use water as a refrigerant. The vacuum pump 14 is operable to hold the interior of the reactor 11 in a depressurized state, and plays an important role in which the exhaust gas containing the fullerenes and soot is introduced from the reactor 11 into the filtering unit 12 through the temperature-regulating unit 17.

Each of the air-feeding ports 34 at the openings 31 is connected to a gas tank 38 through a corresponding opening and closing valve 36 and a gas-pressurizing unit 37. The gas tank 38 supplies a nitrogen gas (an example of inert gases). The system is designed to open the opening and closing valves 36 to blow high-pressured nitrogen gas into the unit filter elements 30 when large amounts of the fullerenes and soot adhere to the unit filter elements 30. As a result, the affixed fullerenes and soot are detached from the unit filter elements 30 while the unit filter elements 30 are reversely cleaned. The unit filter elements 30 are reversely cleaned for each of the gangs. The reverse cleaning allows the fullerene-manufacturing equipment 10 to run continuously.

The casing 24 has a reservoir 40 formed at the lower portion thereof for storing powder containing the fullerenes and soot that has been removed from the unit filter elements 30. The powder accumulated in the reservoir 40 is discharged into a collecting box 43 from the reservoir 40 through an automatic powder-discharging unit 42. The automatic powder-discharging unit 42 includes a first discharge valve 41 located below the reservoir 40. The reservoir 40 includes a thermocouple 44, an instrument that serves to measure a level of the powder deposited in the reservoir 40.

The removal of the powder adhering to the unit filter elements 30 on the outer surfaces thereof accumulates the fullerene-containing soot in the reservoir 40, with a consequential gradual increase in level of the powder. The thermocouple 44 is ultimately buried under the powder, and temperatures detected by the thermocouple 44 are varied. The thermocouple 44 always detects the internal temperature of the reservoir 40, and an amount of the stored powder within the reservoir 40 is detectable in accordance with variations in detected temperatures. The inner surface of the reservoir 40 depressurized to nearly 20 to 200 Torr is regulated in temperature within the range of 300 to 500° C. Such temperature and pressure conditions never allow the accumulated powder to become wet because of moisture, but ensure that the power always has fluidity.

The casing 24 including the reservoir 40 has the inner surface maintained at temperatures of 300° C. or greater. Such inner surface temperatures allow the polycyclic aromatic compounds to be held in a gaseous state, and the gaseous polycyclic aromatic compounds flow through the unit filter elements 30. At this time, very few polycyclic aromatic compounds are mingled with the powder.

The automatic powder-discharging unit 42 includes a substantially conical-shaped, an intermediate vessel 45, the collecting box 43, a discharge pump 47, and a control unit 48. The intermediate vessel 45 is connected to the first discharge valve 41. The collecting box 43 is connected to the intermediate vessel 45 at the bottom thereof through a second discharge valve 46. The discharge pump 47 is operable to reduce the internal pressure of the intermediate vessel 45 and that of the collecting box 43. The control unit 48 is operable to control those components of the automatic powder-discharging unit 42. The intermediate vessel 45 made of, e.g., stainless steel is connected to the discharge pump 47 through an opening and closing valve 49. A pressure sensor 50 is disposed on a pipeline that is connected to the discharge pump 47 through the opening and closing valve 49. The pressure sensor 50 enters an output signal into the control unit 48. The collecting box 43 can be made of, e.g., stainless steel. Another pipeline connects the collecting box 43 to the discharge pump 47 through an opening and closing valve 51. The intermediate vessel 45 and the collecting boxes 43 include respective gas-supplying pipes (not shown), through which the nitrogen gas is supplied thereto.

The control unit 48 includes a programmable controller. The pressure sensor 50 and the thermocouple 44 enter signals into the control unit 48 to control the first and second discharge valves 41, 46 and the opening and closing valves 49, 51 in sequence, thereby transferring the accumulated powder from the reservoir 40 to the collecting box 43 through the intermediate vessel 45. Such transfer control is executed in accordance with programs installed in the control unit 48. The transfer control is performed synchronously with the step of trapping the fullerene-containing soot within the filtering unit 12. As a result, the mixture of the fullerenes and soot is continuously collectable.

The following discusses how the fullerene-manufacturing equipment 10 produces the fullerenes.

The first and second discharge valves 41, 46 as well as all of the opening and closing valves 36 are closed, but all of the opening and closing valves 35 are opened. The vacuum pump 14 is run to depressurize the interior of the reactor 11 and that of the filtering unit 12. The filtering unit 12 introduces vapor into the temperature-regulating jacket 27 through the incoming port thereof, and then discharges the vapor out of the temperature-regulating jacket 27 through the outgoing port thereof, thereby regulating the inner surface temnperature of the filtering unit 12 to, e.g., 200° C. Water is fed into the water-cooling pipe 19 around the piping passage 18, thereby cooling down the piping passage 18.

In the reactor 11, the burner 15 is supplied with toluene (an example of the hydrocarbon fuel) and an oxygen- and argon-mixed gas (an example of oxygen-containing gases) to imperfectly combust them, thereby producing the fullerene-containing soot. The produced, fullerene-containing soot forms a gas flow (an exhaust gas) that is suspended in concomitant gases predominantly containing a carbon monoxide gas and vapor. The gas flow is streamed into the filtering unit 12 through the piping passage 18. The exhaust gas containing the fullerenes and the soot is cooled down during the movement from the reactor 11 through the piping passage 18. For example, although the exhaust gas blown out of the reactor 11 has temperatures of 1,500 to 2,000° C., they are cooled down to the temperature of 400° C. (desirably 300 to 600° C.) when entering the filtering unit 12.

According to the combustion method, the fullerenes are usually produced under a pressure smaller than atmospheric pressure by way of a pressure condition. An appropriate selection can be made as to how much the pressure is reduced. More specifically, an emission volume from the vacuum pump 14 is regulated in such a manner that the reduced pressure falls within the range of, e.g., 20 to 200 Torr (more preferably 30 to 100 Torr).

Conditions on the internal temperature of the reactor 11 may properly be selected based on the pressure conditions as just discussed above. A preferred internal temperature of the reactor 11 falls within the range of 1500 to 2000° C. A particularly preferred internal temperature of the reactor 11 lies within the range of 1700 to 1900° C.

The exhaust gas admitted into the filtering unit 12 is diverted into several streams by the partition plates 32 positioned within the filtering unit 12, with the result that the exhaust gas is uniformly blown into the unit filter elements 30 for each of the filter element gangs. In each of the unit filer elements 30 included in the filter element gangs, the exhaust gas permeates the unit filter elements 30 from the outer surfaces to the inner surfaces thereof, and the fullerenes and soot suspending in the exhaust gas are trapped by the outer surface of each of the unit filter elements 30. In this way, the trapped fullerenes and soot adhere to the unit filter elements 30 on the outer surfaces thereof Meanwhile, the exhaust gas having passed through the unit filter elements 30 is fed into the vacuum pump 14 through the opening and closing valves 35 and the gas-cooling unit 13. The exhaust gas in the vacuum pump 14 is discharged out of the vacuum pump 14 through an exhaust port thereof

After the high-temperature exhaust gas from the reactor 11 is blown into the filtering unit 12 for a predetermined period of time, the fullerene-containing soot adhering to the unit filter elements 30 on the outer surfaces thereof are removed therefrom for each of the filter element gangs. To achieve the purpose, the nitrogen gas is initially introduced from the gas tank 38 into the gas-pressurizing unit 37, in which the nitrogen gas is pressurized to predetermined gas pressures of e.g., 0.001 to 0.1 Mpa. Subsequently, each of the opening and closing valves 36 is opened for corresponding one of the unit filter elements 30 in each of the filter element gangs, from which the fullerene-containing soot is to be removed. Each of the opened valves 36 is connected, through an exhaust pipe, to the air-feeding port 34 on corresponding one of the unit filter elements 30. When each of the opening and closing valves 36 are opened as previously discussed, the nitrogen gas is brought into corresponding one of the unit filter elements 30 through the opening 31.

The nitrogen gas is blown out of the unit filter elements 30 from the inner surfaces to the outer surfaces thereof At that time, the nitrogen gas blown out of the unit filter elements 30 rips and lifts the fullerenes and soot off the outer surfaces of the unit filter elements 30, thereby removing the fullerenes and soot therefrom. The blown nitrogen gas is mingled with the exhaust gas from the reactor 11. The mingled nitrogen gas is moved toward the vacuum pump 14 through the other unit filter elements 30. When the removal of the fullerenes and soot from the unit filter elements 30 caused by the jets of the nitrogen gas through the unit filter elements 30 for a predetermined period of time is completed, the opening and closing valves 36 are closed, the gas-pressurizing unit 37 is stopped, and the opening and closing valves 35 are opened. When the opening and closing valves 35 are opened, the trapping of the fullerene-containing soot is resumed in each of the filter element gangs where the removal of the fullerenes and soot from the unit filter elements 30 has been completed. In the other filter element gangs, the same operations as described above are performed in sequence to remove the adhered fullerene-containing soot from the outer surfaces of the unit filter elements 30.

The fullerene-containing soot ripped off the unit filter elements 30 is accumulated in the form of powder in the reservoir 40 at the lower portion of the filtering unit 12. The thermocouple 44 in the reservoir 40 detects the temperature of the exhaust gas flowing in the reservoir 40 until the thermocouple 44 is buried under a gradually increasing amount of the fullerene-containing soot built up in the reservoir 40. The thermocouple 44 buried under the fullerene-containing soot detects the temperature of the fullerene-containing soot, and the detected temperature is varied. When the variation in temperature enters the control unit 48, the control unit 48 runs the discharge pump 47 and opens the opening and closing value 49, thereby evacuating the intermediate vessel 45. At that time, when an oxygen-containing gas such as air is present in the intermediate vessel 45, the nitrogen gas is introduced into the intermediate vessel 45 through the gas-supplying pipe (not shown) to replace the oxygen-containing gas by the nitrogen gas before the intermediate vessel 45 is evacuated. The internal pressure of the intermediate vessel 45 is detected using the pressure sensor 50 to determine whether the intermediate vessel 45 is consistent in internal pressure with the filtering unit 12. When the intermediate vessel 45 is matched in internal pressure with the filtering unit 12, the opening and closing valve 49 is closed to stop degassing the intermediate vessel 45.

Subsequently, the first discharge valve 41 is opened to permit the powder formed by the mixture of the fullerenes and soot to fall into the intermediate vessel 45 from the reservoir 40. Then, the first discharge valve 41 is closed. The opening and closing valve 51 is opened to evacuate the collecting box 43. When the internal pressure of the collecting box 43 is reduced below that of the intermediate vessel 45, the first discharge vale 41 is closed. Thereafter, the second discharge valve 46 is opened to transfer the powder from the intermediate vessel 45 into the collecting box 43. Then, the second discharge valve 46 is closed. Next, the nitrogen gas is introduced into the collecting box 43 through a gas-supplying pipe (not shown) to pressurize the interior of the collecting box 43 to a degree equal to atmospheric pressure. The pressurized collecting box 43 is sealed. The sealed collecting box 43 is detached from the second discharge valve 46 to bring the fullerene-containing soot to the next processing stage at which the fullerenes are separated from the soot.

The fullerene-containing soot can be separated into the fullerenes and carbonaceous high-molecular-weight constituents (the soot) in accordance with any method. For example, there is a representative method operable to mix an extractant with a soot mixture that includes the fullerenes and carbonaceous high-molecular-weight constituents, thereby providing an extract fluid in which the fullerenes are dissolved. There is another representative method operable to sublimate and separate the fullerenes from the above-described soot mixture by heating the soot mixture at high temperatures in the presence of an inert gas, i.e., in the absence of oxygen.

By way of an example of the extractant for use in the acquirement of the extract fluid containing the dissolved fullerenes, an aromatic hydrocarbon operable to dissolve only the fullerenes, not the soot is used. The aromatic hydrocarbon can be any hydrocarbon compound having at least one benzene nucleus in a molecule. More specifically, the aromatic hydrocarbon includes alkylbenzenes such as benzene, toluene, xylene, ethylbenzene, n-propylbenezen, isopropylbenzene, n-butylbenzene, sec-butylbenzene, tert-butylbenzene, 1,2,3-trimethylbenzene, 1,2,4-trimethylbenzene, 1,3,5-trimethylbenzene, 1,2,3,4-tetramethylbenzene, 1,2,3,5-tetramethylbenzene, diethylbenzene, and cymene, alkylnaphthalenes such as 1-methylnaphthalene, and tetralin.

The solvent containing the dissolved fullerenes is vaporized to collect the fullerenes from the solvent.

As illustrated in FIG. 1, the present embodiment employs the inverted reactor 11 having the burner 15 and the exhaust port 16 formed at the upper and lower portions thereof, respectively. Alternatively, an upright reactor 57 may be used, as illustrated by chain double-dashed lines in FIG. 1. The upright reactor 57 has a burner 55 and an exhaust port 56 provided at lower and upper portions thereof, respectively. In the alternative, however, the soot generated within the reactor 57 falls and settles onto the burner 55. The reactor 57 must be cleaned at appropriate time intervals. As a further countermeasure, the exhaust gas may be streamed at higher speeds within the reactor 57 to prevent the soot from falling by gravity.

The filtering unit 12 according to the present embodiment may employ a different type of unit filter elements 30 by way of an alternative, each of which includes a vibrator, an example of a vibrating unit operable to vibrate each of the unit filter elements 30. The use of the vibrators makes it feasible to remove the attached powder more effectively from the unit filter elements 30.

In the method for producing the fullerenes according to the present embodiment, the unit filter element made of sintered metal is used as a heat-resistant filtering member. As an alternative, a heat-resistant filtering member made of porous ceramics may be employed. In this instance, the porous ceramic unit filter element can be used under conditions similar to those of the sintered metallic unit filter element. However, the porous ceramic unit filter element is disadvantageously reduced in strength, and must be double to five times as thick as the sintered metallic unit filter element. In addition, a greater number of the porous ceramic unit filter elements must be used.

### EMPIRICAL EXAMPLES

The following discusses experiments that were conducted to assure the function and effects of the present invention.

Experiment No. 1

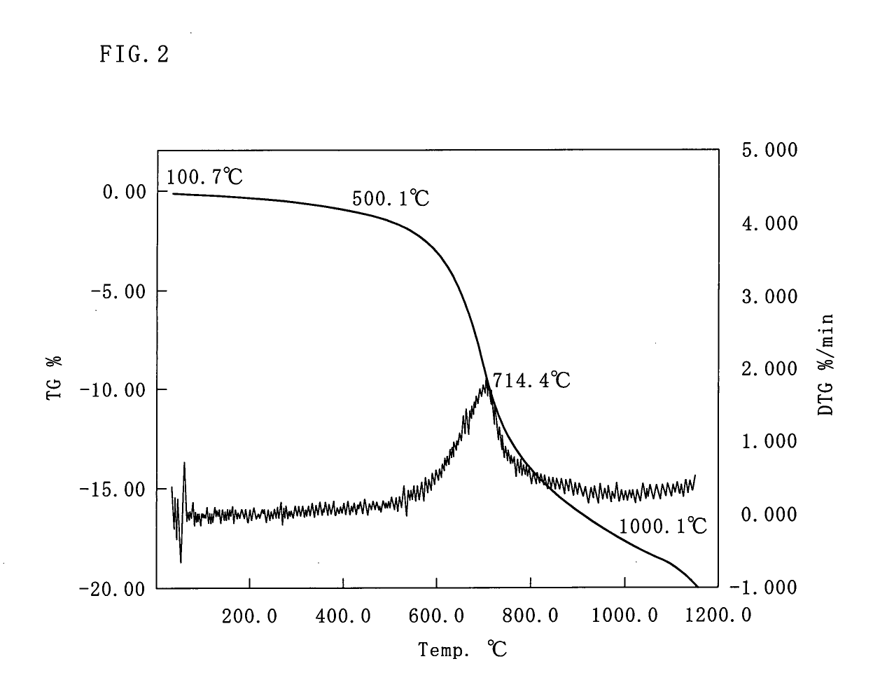

A change in weight of fullerene-containing soot in an amount of 3.8 mg was measured using a thermogravimetric measuring apparatus (manufactured by Seiko Inc., model TG-DTA6300). The fullerene-containing soot was produced in accordance with the combustion method using toluene as a raw material. To measure the weight change, the soot placed in a dry nitrogen gas of 100 cc per minute was heated up to 1,150° C. from an indoor temperature. In this instance, the temperature was increased by 20° C. per minute. FIG. 2 shows results from the experiment. In FIG. 2, a leftward vertical axis, a rightward vertical axis, and a horizontal axis show weight reduction percentages with reference to the weight of 3.8 mg, variation percentages of the weight reduction percentage, and heating temperatures, respectively. As evidenced by the weigh reduction-showing graph and weight variation percentage-showing graph in FIG. 2, it is found that the weight was reduced in steps when the temperature reached 100° C. or greater, and further that a reduction in weight accelerated at temperatures of nearly 400° C. In the high-temperature region of 600° C. or greater, the fullerene-containing soot was dramatically reduced in weight. Since the fullerenes were sublimated at temperatures of 400 to 800° C., it is found that the sublimation of a large amount of the fullerenes in the soot dramatically reduced the weight of the soot.

Experiment No. 2

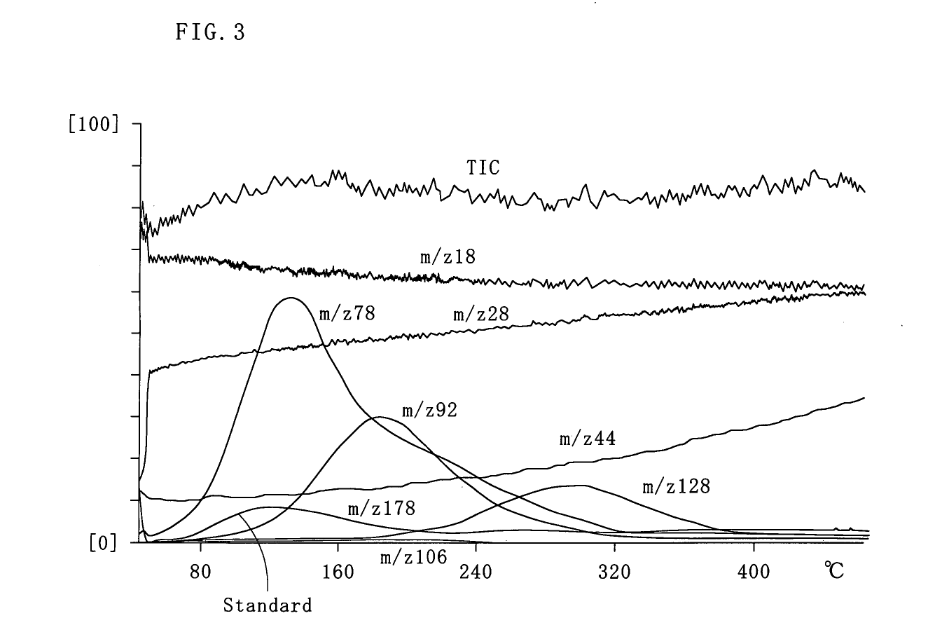

The present experiment employed, as a sample, fullerene-containing soot produced in accordance with a conventional combustion method in which the filtering unit had the entrance temperature of 150° C. or less. The fullerene-containing soot was heated to generate gases. The gases were checked to measure constituents thereof using a quadrupole mass spectrometer (manufactured by Japan Electron Optics Laboratory Co., LTD, model Automath AM2-15). FIG. 3 shows results from the measurement. The following shows fundamental measurement conditions:
Measurement process: Electron Ionization
Furnace temperature: 290° C.
Transfer tube temperature: 285° C.
GC oven temperature: 285° C.
Interface temperature: 285° C.
Ionization room temperature: 260° C.
Photo multiplier voltage: 450 V
Ionizing voltage: 70 eV
Ionizing current: 300 μA
Mass range: 10 to 400 amu
Scan speed: 1000 msec

In FIG. 3, vertical and horizontal axes denote the relative intensity of ion spectra and heating temperatures, respectively. The gases resulting from the heating of the fullerene-containing soot contained aromatic compounds such as benzene, toluene, and xylene and polycyclic aromatic compounds such as naphthalene and anthracene. It was ascertained from FIG. 3 that a peak showing the presence of the aromatic compounds and polycyclic aromatic compounds fell within the range less than temperatures at which the fullerenes were sublimated. As a result, it is found that the polycyclic aromatic compounds as well as the aromatic compounds such as benzene were almost all vaporized at temperatures of 300° C. or greater. It is further found that substantially all of the aromatic compounds and polycyclic aromatic compounds were vaporized at temperatures of 350° C. or greater. In FIG. 3, TIC and m/z denote a total ion chromatograph and a molecular weight, respectively. More specifically, m/z18 denotes water; m/z28 CO, m/z44 CO₂; m/z78 benzene; m/z92 toluene; m/z106 xylene; m/z128 naphthalene; and m/z178 anthracene.

The above experimental embodiment demonstrates that almost all of the polycyclic aromatic compounds can be removed in the form of gas by heating the exhaust gas at the temperatures of 300° C. or greater (preferably 350° C. or greater). The exhaust gas resulted from the combustion method, and contained the fullerenes and the soot (carbonaceous high-molecular weight constituents). Part of the exhaust gas contained the polycyclic aromatic compounds (monocyclic or bi-cyclic aromatic compounds such as, e.g., benzene and toluene). Furthermore, it is found that a majority of the fullerenes were non-vaporized when the exhaust gas was heated at temperatures of at most 600° C. (preferably at most 550° C.). As a result, it is understood that a mixture of the fullerenes and soot in the form of powder excluding the polycyclic aromatic compounds can be collected by permitting the exhaust gas maintained at temperatures of 300 to 600° C. to flow through the filtering unit 12.

Experiment No. 3

Fullerenes were produced using the fullerene-manufacturing equipment 10 of FIG. 1. The burner 15 at the upper portion of the reactor 11 was formed by a circular plate-like, porous ceramic sintered body having an outer diameter of 250 mm. The porous ceramic sintered body was formed with minute apertures as discharge ports (ejection ports). The number of the apertures present in the porous ceramic sintered body for each 25 mm² ranges from 20 to 150.

A toluene gas and pure oxygen were used as a hydrocarbon fuel and an oxygen-containing gas, respectively. The toluene gas was a gaseous constituent produced by heating toluene using an evaporating unit. The gaseous toluene was heated to the temperature of 200° C. using a heat exchanger. The oxygen gas was supplied from an oxygen tank to the heat exchanger, in which the supplied oxygen gas was heated to the temperature of 200° C. The toluene gas having the flow rate of 435 grams per minute and the oxygen gas having the flow rate of 328.1 grams per minute were supplied to the burner 15, in which those two different gases were premixed together, thereby providing a mixed gas. The mixed gas was ejected out of the burner 15 into the reactor 11. At that time, the internal pressure of the reactor 11 was 40 Torr. The average flow velocity of the mixed gas discharged out of the burner 15 was 302 cm per second at 298K.

The fullerenes were produced under the conditions as discussed above. The gases had the temperature of 1400° C. when leaving the reactor 11 through the exit thereof, but had temperatures of 480 to 500° C. when entering the filtering unit 12. As a result, the fullerenes “B” mixed with the by-product (soot “A”) accounted for 17.0% of the mixture of the fullerenes B and the soot “A”, as determined from a formula (B/(A+B)). No soot was seen to adhere to the burner 15 at the ejection portion thereof, and the reactor 11 was able to run continuously. It was ascertained that, when the soot sticking to the inner surface of the reactor 11 fell therefrom, high-speed gas flow thrust the falling soot out of the reactor 11.

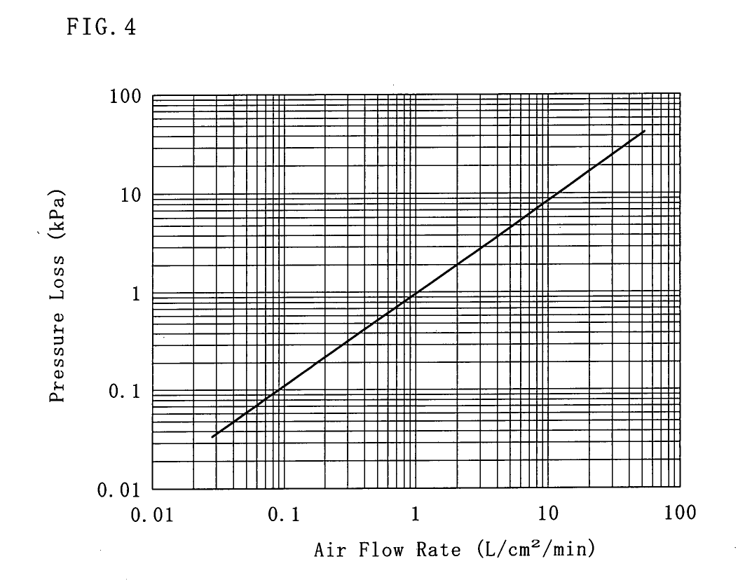

FIG. 4 illustrates a pressure loss of one of the sintered metallic unit filter elements 30 with reference to a gas flow rate. The illustrated unit filter element 30 was made of austenitic stainless steel (18 chrome-8 nickel), an example of the heat-resistant filtering member used in the method for producing the fullerenes according to the embodiment of the present invention. The unit filter element 30, made of sintered metal, is substantially 0.56 mm thick. The unit filter element 30 results in the pressure loss of some 7.5 Torr with reference to gas flow rate 1 L/cm²/minute (L=liter). The cylindrical unit filter element 30 was 65 mm in outer diameter, and was 2500 mm long. The number of the unit filter elements 30 of this type used in the filtering unit 12 of FIG. 1 was 78. Those unit filter elements 30 were divided into six gangs, in each of which the unit filter elements 30 were connected to the gas-pressurizing unit 37 and the nitrogen gas tank 38 through the opening and closing valves 36. When the opening and closing valves 36 were opened in turn, the unit filter elements 30 could be reversely cleaned in corresponding sequence.

A pressure sensor was disposed in each of the filter element gangs. When a difference in pressure between the pressure sensor and another pressure sensor disposed within the filtering unit 12 outside the unit filter elements 30 exceeded a reverse cleaning start pressure that was determined by an appropriate value (e.g., 10 Torr) between 7.5 and 11.3 Torr, a particular group of the opening and closing valves 36 was operated to reversely clean corresponding one of the filter element gangs, provided the other filter element gangs were not being reveresely cleaned. The unit filter elements 30 were reversely cleaned by blowing an inert gas such as a nitrogen gas of the pressure of 0.4 MPa (some 4 kgfcm⁻²) out of each of the unit filter elements 30 from the interior to the exterior thereof The reverse cleaning was conducted for nearly two to ten minutes. In this instance, the opening and closing valves 36 may be switched on and off to apply pulse-like pressures to the interiors of the unit filter elements 30. It was programmed that, when the pressures in a plurality of the filter element gangs exceeded the reverse cleaning start pressure at a time or at staggered time intervals, one of the filter element gangs was preferentially cleaned reversely, which was either in receipt of a reverse cleaning start signal earlier than the remaining filter element gangs or reversely cleaned last time earlier than the remaining filter element gangs. It was further programmed that, when the preferentially selected filter element gang was completely cleaned reversely, the next filter element gang was reversely cleaned.

According to the present experiment, a gas flow rate and a gas temperature in the piping passage 18 were 55 Nm³ per hour and 500° C., respectively. At this time, the pressure within the filtering unit 12 outside the unit filter elements 30 was 34.5 Torr. Those conditions forced the fullerene-containing soot to adhere to the unit filter elements 30 on the outer surfaces thereof, thereby filtering the fullerene-containing soot. When a difference in pressure inside and outside any one of the filter element gangs exceeded the reverse cleaning start pressure, the unit filter elements in that particular filter element gang were reversely cleaned. A difference in pressure inside and outside the filter element gang after the completion of the reverse cleaning was 4.5 Torr, but a difference in pressure inside and outside the same filter element gang immediately before the start of the reverse cleaning was 7.5 to 11.3 Torr.

After the operations as discussed above were repeated, the fullerene-containing soot in an amount of 156 kg was collected or gathered for 120 hours. No soot was found to stick to the unit filter elements 30 on the outer surfaces thereof, and the operations were continuously executable.

1. A method for producing fullerenes, comprising:
a first process of either imperfectly combusting or thermally decomposing a hydrocarbon fuel in a reactor, thereby producing a high-temperature gas flow containing fullerenes and soot;
a second process of collecting a mixture of the fullerenes and the soot from the gas flow containing the fullerenes and the soot using a filtering unit, said filtering unit including a heat-resistant filtering member made of either one of a porous ceramic material and a porous metal material as a raw material; and
a third process of collecting the fullerenes from the mixture.

2. A method for producing fullerenes as defined in claim 1, wherein the high-temperature gas flow generated by said first process is regulated in temperature by a temperature-regulating unit to a range of more than 300 to 600° C.

3. A method for producing fullerenes as defined in claim 1, wherein said collecting the fullerenes according to said third process comprises dissolving the mixture into a solvent to collect and separate the fullerenes from the mixture.

4. A method for producing fullerenes as defined in claim 1, wherein said collecting the fullerenes according to said third process comprises heating the mixture to an elevated temperature in the absence of oxygen to vaporize the fullerenes, thereby separating the fullerenes from the soot.

5. A method for producing fullerenes as defined in claim 1, wherein said heat-resistant filtering member has a filtration flow capability to filter the gas flow that streams through said heat-resistant filtering member, the filtration flow capability being in a range of 0.2 to 10 m³ /m²/minute.

6. A method for producing fullerenes as defined in claim 1, wherein said reactor has an exhaust port provided at a lower portion of said reactor, the high-temperature gas flow containing the fullerenes and the soot being discharged out of said reactor through said exhaust port.

7. A method for producing fullerenes as defined in claim 6, wherein said reactor has a burner provided at an upper portion of said reactor for either imperfectly combusting or thermally decomposing the hydrocarbon fuel.

8. A method for producing fullerenes as defined in claim 1, wherein said filtering unit includes a plurality of cylindrical-shaped unit filter elements, each of which is made of said heat-resistant filtering member, and each of which has a bottom, said plurality of cylindrical-shaped unit filter elements being divided into plural gangs; and
wherein the gas flow is streamed through each of said unit filter elements from outside of each of said unit filter elements to inside of each of said unit filter elements.

9. A method for producing fullerenes as defined in claim 8, wherein, when said unit filter elements get clogged up, an inert gas is fed through said unit filter elements from inside to outside of each of said unit filter elements, thereby removing the mixture from said unit filter elements.

10. A method for producing fullerenes as defined in claim 9, wherein said removing the mixture from said unit filter elements using the inert gas comprises removing the mixture from said unit filter elements for each of the plural gangs.
